(19) United States
(12) Patent Application Publication
(10) Pub. No.: US 2009/0102548 A1
(43) Pub. Date: Apr. 23, 2009

(54) Coil enhancement circuit

(75) Inventor: Edmond Celina Jozef Op De Beeck, Mechelen (BE)

Correspondence Address: HARNESS, DICKEY & PIERCE, P.L.C., P.O. BOX 8910, RESTON, VA, 20195, US

(73) Assignee: ALCATEL LUCENT

(21) Appl. No.: 12/285,811

(22) Filed: Oct. 15, 2008

(30) Foreign Application Priority Data
Oct. 18, 2007 (EP) 07291275.1

(51) Int. Cl. G05F 5/00

(52) U.S. Cl. 327/594

(57) ABSTRACT

An enhancement circuit for enhancing the value of a coil having a first winding. The enhancement circuit comprises a second winding forming a transformer with the first winding and having a first terminal coupled to the ground and a second terminal coupled to an input of a feedback circuit. The feedback circuit senses the voltage over the coil and comprises a transconductance amplifier that amplifies and converts the sensed voltage into a current injected back in the second winding. In a preferred embodiment, the coil has a pair of windings and is used in a double-ended low-pass filter, as an xDSL splitter for telecommunication applications. The pair of windings is then coupled between telecommunication input terminals and output terminals of the low-pass filter. The improved enhancement circuit comprises a third and a fourth winding both coupled to the first and second windings. The third winding has a first terminal coupled to the ground and a second terminal coupled to the input of the feedback circuit, whilst the fourth winding has a first terminal also coupled to the ground and a second terminal coupled to the output of the feedback circuit. This feedback circuit senses the voltage over the coil and comprises a transconductance amplifier that amplifies and converts the sensed voltage into a current injected in the fourth winding via the second terminal thereof.

The present invention relates to an enhancement circuit for enhancing the value of a coil of which the winding is coupled between an input terminal and an output terminal.

Today, coil based filters, as for instance xDSL splitter circuits of telecommunication systems, generally require multiple coils in multiple filter stages to realize the complex filter function that is required. In more detail, today's xDSL splitter circuits use up to 3 bulky coils per DSL line, limiting the integration of the number of splitter circuits per board. As a result, the density of standard compliant splitters has not been able to follow the increasing integration of the xDSL line circuits, resulting in a different numbers of lines per boards between splitters and line circuits.

Known solutions to that problem consist in using a passive filter or an active splitter based on coil enhancement applying the current sensing and current driving principle.

In case of a passive filter, a 3rd order passive splitter has a higher density than a 5th order because it uses only 2 instead of 3 coils. However, this is not standard compliant for attenuation of DSL signals.

The active splitter based on coil enhancement applying the current sensing and current driving principle is known from the European Patent Application No 06291502.0 Entitled “Multiple Order Low Pass Filter for An xDSL Splitter in a Telecommunication System” by E. Op De Beeck (22.09.2006). However, this implementation has practical drawbacks, e.g. for density and cost, due to requirements for common mode rejection, longitudinal conversion loss and protection against over-voltages and over-currents.

An object of the present invention is to provide an enhancement circuit for a coil of the above type but which doesn't have the mentioned drawbacks while consuming a minimum of place on the board.

According to the invention, this object is achieved due to the fact that said enhancement circuit comprises a second winding coupled to the first mentioned winding so as to form a transformer, that said second winding has a first terminal coupled to a ground terminal and a second terminal coupled to an input of a feedback circuit, and that said feedback circuit is adapted to sense the voltage over said coil and comprises a transconductance amplifier adapted to amplify and to convert the sensed voltage to a current injected in said second winding via said second terminal.

In this way it becomes possible to increase and even reduce the value of the coil, and make the coil frequency dependent. This allows to make higher order filters based on a coil and capacitor, with less and smaller coils. The present solution is even less dense than the above mentioned solution of a 3rd order passive splitter while providing better performances.

In a preferred characterizing embodiment of the present invention, said enhancement circuit comprises a second winding and a third winding both coupled to the first mentioned winding so as to form a transformer, said second winding has a first terminal coupled to a ground terminal and a second terminal coupled to an input of a feedback circuit, said third winding has a first terminal coupled to said ground terminal and a second terminal coupled to an output of said feedback circuit, and said feedback circuit is adapted to sense the voltage over said coil and comprises a transconductance amplifier adapted to amplify and to convert the sensed voltage to a current injected in said third winding via the second terminal thereof.

The use of different winding for voltage sensing and current driving, as will be explained below, allows eliminating the parasitic effects of the transformer.

In another preferred characterizing embodiment of the invention, the present enhancement circuit enhances the value of a coil having a pair of windings and used in a double-ended low-pass filter, the first winding of said pair is coupled between a first input terminal and a first output terminal of said low-pass filter, and the second winding of said pair is coupled between a second input terminal and a second output terminal of said low-pass filter. A capacitor is coupled between the first output terminal and the second output terminal of said low-pass filter, and said first winding and said second winding are coupled together so as to form a transformer. This enhancement circuit comprises a third winding and a fourth winding both coupled to said first and said second windings and belonging also to said transformer, said third winding has a first terminal coupled to a ground terminal and a second terminal coupled to an input of a feedback circuit, said fourth winding has a first terminal coupled to said ground terminal and a second terminal coupled to an output of said feedback circuit, and said feedback circuit is adapted to sense the voltage over said coil and comprises a transconductance amplifier adapted to amplify and to convert the sensed voltage to a current injected in said fourth winding via the second terminal thereof.

By applying the enhanced coils of the present invention in the low pass filter of an xDSL POTS splitter of a telecommunication system, a multiple order splitter low pass filter is realized.

Further characterizing embodiments of the present coil enhancement circuit are mentioned in the appended claims.

It is to be noticed that the term ‘comprising’, used in the claims, should not be interpreted as being restricted to the means listed thereafter. Thus, the scope of the expression ‘a device comprising means A and B’ should not be limited to devices consisting only of components A and B. It means that with respect to the present invention, the only relevant components of the device are A and B.

Similarly, it is to be noticed that the term ‘coupled’, also used in the claims, should not be interpreted as being restricted to direct connections only. Thus, the scope of the expression ‘a device A coupled to a device B’ should not be limited to devices or systems wherein an output of device A is directly connected to an input of device B. It means that there exists a path between an output of A and an input of B which may be a path including other devices or means.

The above and other objects and features of the invention will become more apparent and the invention itself will be best understood by referring to the following description of an embodiment taken in conjunction with the accompanying drawings wherein:

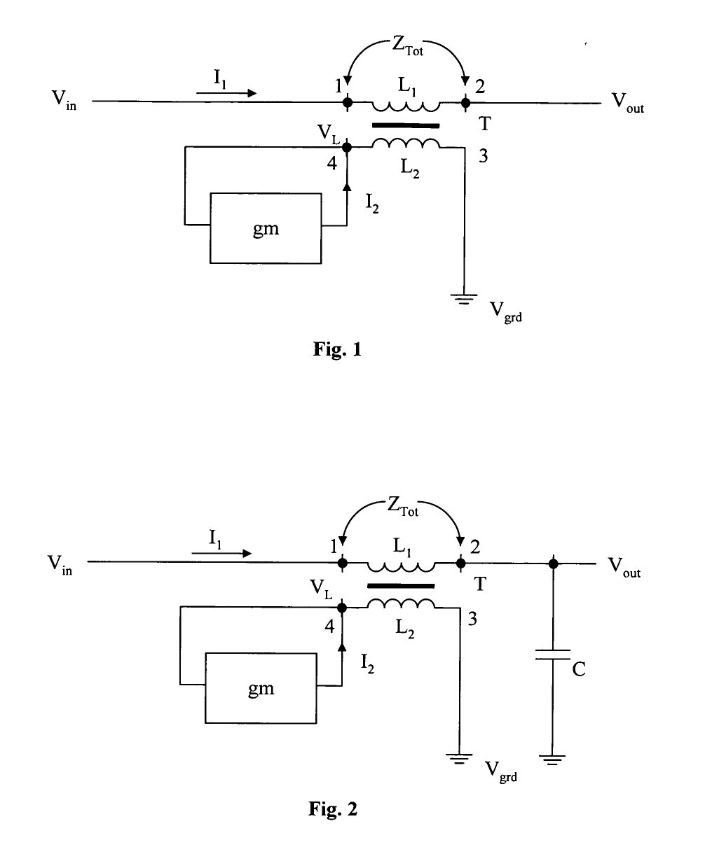

FIG. 1 represents a coil with an enhancement circuit according to the invention;

FIG. 2 represents the enhanced coil of FIG. 1 applied in a low pass filter;

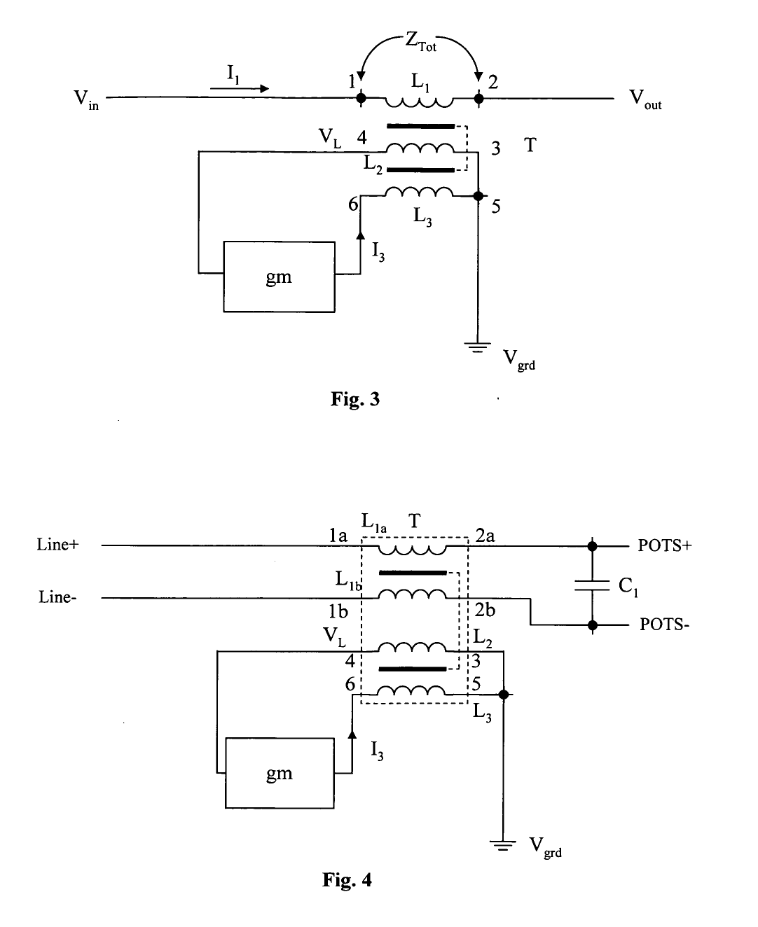

FIG. 3 represents the enhanced coil of FIG. 1 applied in a preferred embodiment;

FIG. 4 represents the enhanced coil of FIG. 3 applied in the low pass filter of an xDSL POTS splitter; and

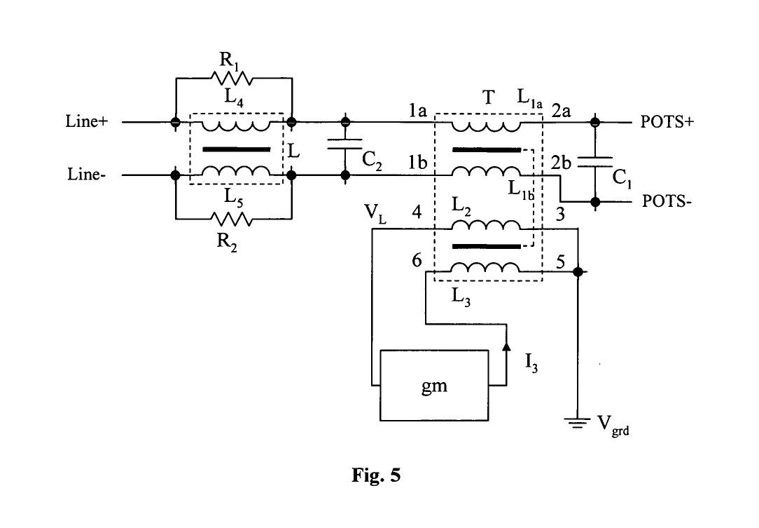

FIG. 5 represents a preferred variant of the low pass filter shown in FIG. 4.

An enhancement circuit for enhancing the value of a coil is shown at the different Fig's. The principle for enhancing the value of a coil is achieved by:

sensing the voltage over the coil, on a secondary winding coupled to the coil as a transformer T;

amplifying and converting this sensed voltage to a current in a transconductance amplifier gm; and

sending this current again in the secondary winding of the coil.

This principle allows increasing and even reducing the value of the coil, and making the coil frequency dependent. It further allows making higher order filters based on a coil and capacitor, with less and smaller coils.

Different embodiments of the enhancement circuit and applications thereof are shown in the Fig's.

A first enhancement of the value of a coil, having a winding L₁ and shown at FIG. 1, is obtained by sensing the voltage over the coil at a secondary winding L₂ thereof, filtering and amplifying this sensed voltage, converting it into a current I₂, and feeding it back to the secondary winding L₂ of the coil.

This enhanced coil circuit is then applied in a low pass filter, shown at FIG. 2, in order to realize a higher order low pass filter based on a single coil (transformer) and a capacitor C.

FIG. 3 shows the use of different windings for voltage sensing and for current driving in order to eliminate the parasitic effects of the transformer T.

FIG. 4 shows the application of this filter in the low pass filter of an xDSL POTS splitter, to realize multiple order splitter low pass filter.

An improved version of this xDSL POTS splitter is shown at FIG. 5.

The basic principle of the enhancement circuit is shown in FIG. 1. In this circuit, the coil has a first winding L₁ with a first terminal 1 coupled to an input terminal Vin and with a second terminal 2 coupled to an output terminal Vout. This coil has a second winding L₂ coupled to the first winding L₁ so as to form a transformer T. This second winding L₂ has a first terminal 3 connected to a ground terminal Vgrd and a second terminal 4 coupled to an input of a feedback circuit. The feedback circuit comprises a transconductance amplifier gm which, together with the second winding L₂, forms the enhancing circuit for the coil.

The feedback circuit is adapted to sense the voltage V_{L} over the coil via an input of its transconductance amplifier gm connected to the second terminal 4 of the second winding L₂. The transconductance amplifier gm amplifies this sensed voltage and converts it into a current I₂ injected back in the second winding L₂ via its second terminal 4.

For the ease of the explanation of this coil enhancement circuit, it is assumed that:

L₁=L₂; this means n=1

where n is the winding ratio of transformer T

Without feedback circuit, the total impedance Zₜₒₜ provided by the winding L₁ is given by the formula:

Zₜₒₜ=s*L₁

The current I₂ is generated by sensing the voltage V_{L} at the secondary of the transformer T, and by amplifying this voltage and converting it to a current in the transconductance amplifier gm:

I₂=gm*V_{L}

The total impedance Zₜₒₜ between input terminal Vin and output terminal Vₒᵤₜ, with the feedback loop present via the secondary of the transformer T, is given by following formula:

$$\begin{matrix}{Z}_{tot} = ( s * {L}_{1} ) / ( 1 - gm * s * {L}_{1} ) \\ = {Z}_{L 1} / ( 1 - gm * {Z}_{L 1} )\end{matrix}$$

where Z_{L1}=s*L₁

This means that impedance Zₜₒₜ is equivalent to impedance Z_{L1} in parallel with the negative impedance −1/gm.

The resulting coil value Lₜₒₜ can be described as:

Lₜₒₜ=L₁/(1−gm*s*L₁)

Based on the sign and the amplitude of gm, the resulting coil value Lₜₒₜ can be higher (enhanced coil) or lower (reduced coil) than the original coil L₁:

0<gm*s*L₁<1=enhanced coil

gm*s*L₁<0=reduced coil

The open loop gain G_{OL} of the feedback loop is given by following equation:

G_{OL}=gm*(Z_{L1}//Zₑₓₜ)

where Z_{L1}//Zₑₓₜ is the impedance of L₁, parallel with the external impedance Zₑₓₜ, seen across L₁

The standard stability criteria apply to the open loop gain.

In the way described above, the value of a coil can be adapted, by adapting the gain of a feedback circuit applied to this coil. This allows enhancing or reducing the value of the coil, and even making the value of the coil frequency dependent, by making the feedback circuit frequency dependent. The explained principle also shows good performance for common mode rejection, longitudinal conversion loss and protection against over-voltages and over-currents, as the feedback circuit is isolated via transformer T from the primary winding (L₁) of the coil.

The above enhanced coil principle may be applied in a low pass filter to realize a higher order low pass filter based on a single coil (transformer) and capacitor, as shown at FIG. 2. To this end, in addition to the above described coil enhancement circuit, a capacitor C is coupled between the output terminal Vout and the ground terminal Vgrd.

The filter characteristic without L₂ and without feedback is given by:

Vout/Vin=1/(1+s²*L₁*C)

The filter characteristic with L₂ and with the feedback circuit is given by:

Vout/Vin=1/(1+s²*Lₜₒₜ*C)=/(1+s²*(L₁/(1−gm*s*L₁))*C)

By making the sign (phase) and amplitude of gm frequency dependent, the value of the coil Lₜₒₜ, and the impedance Zₜₒₜ, can be changed over the frequency, allowing higher order filters or complex filter functions, with a single coil.

An improvement of the above coil enhancement circuit is shown at FIG. 3 where different windings L₂ and L₃ are used for voltage sensing (L₂) and current driving (L₃). These different windings allow eliminating the parasitic effects of the transformer T.

In more detail, the enhancement circuit shown at FIG. 3 comprises, as in FIG. 1, a coil with a first winding L₁ having a first terminal 1 coupled to the input terminal Vᵢₙ and a second terminal 2 coupled to the output terminal Vₒᵤₜ. The circuit of FIG. 3 further comprises a second winding L₂ and a third winding L₃ both coupled to the winding L₁ of the coil so as to form a transformer T. The second winding L2 has a first terminal 3 coupled to the ground terminal V_{grd} and a second terminal 4 coupled to the input of the feedback circuit. The third winding L₃ has a first terminal 5 coupled to the ground terminal V_{grd} and a second terminal 6 coupled to the output of the feedback circuit.

As above, the feedback circuit is adapted to sense the voltage V_{L} over the coil and comprises a transconductance amplifier gm adapted to amplify and to convert the sensed voltage into a current I₃ injected in the third winding L₃ via its second terminal 6.

It is to be noted that, with respect to the enhancement circuit shown at FIG. 1, the voltage V_{L} sensed over the secondary winding L₂ needs to give an exact representation of the coil. In practice however, there is a resistance in series with the coil (winding resistance R_{S} of L₁, not shown), that creates an additional voltage I₂*R_{S} that also contributes to V_{L}. This gives an error on the generated current I₂ at the output of the transconductance amplifier gm.

The resulting impedance, for the implementation in FIG. 1, is given by following formula:

Zₜₒₜ=(s*L₁)/(1−(gm*s*L₁)/(1−gm*R_{S}))

Since R_{S} is not exactly known (parasitic of the transformer T), it is relatively difficult to compensate this. Overcompensation of R_{S} would lead to instability; undercompensation will reduce the resulting impedance Zₜₒₜ.

By adding an additional winding L₃ to the transformer T, i.e. separating the winding L₂ for voltage sense and the winding L₃ for current drive, together with a high input impedance of the voltage sense input of the gm amplifier, this problem is eliminated. The resulting schematic is given at FIG. 3.

When L₁=L₂=L₃, the same formulae as in embodiment of FIG. 1 (with R_{S}=0) apply.

When the winding ratios between L₁, L₂ and L₃ are not equal to 1, the formula for Zₜₒₜ is given below:

Zₜₒₜ=(s*L₁)/(1−gm*s*L₁/(n₁₂*n₂₃))

Where
n₁₂=winding ratio L₁ versus L₂=√(L₁/L₂)
n₁₃=winding ratio L₁ versus L₃=√(L₂/L₃)

The improvement of the coil enhancement circuit, by adding an additional winding as shown in FIG. 3, shows how to deal with the parasitic effects of the transformer in a fairly simple way.

The above enhanced coil principle may also be applied in the low pass filter of an xDSL POTS splitter used in telecommunication systems. The enhanced coil circuit then allows realizing a multiple order splitter low pass filter.

FIG. 4 shows a single stage implementation comprising one active stage with an enhanced coil, while FIG. 5 shows a two-stage implementation comprising one passive and one active stage with enhanced coil.

In more detail, the enhancement circuit shown at FIG. 4 enhances the value of a coil having a pair of windings L₁ₐ, L_{1b} and used in a double-ended low-pass filter. The first winding L₁ₐ of this pair is coupled between a first telecommunication input terminal Line+ and a first output terminal POTS+ of the low-pass filter, whilst the second winding L_{1b} of the pair is coupled between a second telecommunication input terminal Line− and a second output terminal POTS− of this low-pass filter.

The first winding L₁ₐ and the second winding L_{1b} are coupled together so as to form a transformer T, and more particularly the primary thereof. Because in xDSL balanced signals are used, the two windings L₁ₐ and L_{1b} of the primary of the transformer T are balanced windings.

A capacitor C₁ is coupled between the first output terminal and the second output terminal of the low-pass filter.

The enhancement circuit further comprises a third winding L₂ and a fourth winding L₃ both coupled to the first L₁ₐ and the second L_{1b} windings and belonging also to the transformer T. The third winding L₂ has a first terminal 3 coupled to the ground terminal V_{grd} and has a second terminal 4 coupled to the input of the feedback circuit, whilst the fourth winding L₃ has a first terminal 5 coupled to the ground terminal V_{grd} and has a second terminal 6 coupled to the output of the feedback circuit.

As mentioned above, the feedback circuit is adapted to sense the voltage V_{L} over the coil and comprises a transconductance amplifier gm adapted to amplify and to convert the sensed voltage to a current I₃ injected in the fourth winding L₃ its second terminal 6.

Depending on the application and requirements, the implementation can use a single stage approach as shown at FIG. 4 or a dual stage approach as shown at FIG. 5. Also depending on the application (e.g. POTS versus ISDN) the principle used can be enhanced (increased) coil or reduced (suppressed coil) or a combination of both.

In the dual stage approach shown at FIG. 5, the low-pass filter further comprises an additional second coil having a second pair of windings L₄, L₅ coupled between the telecommunication input terminals Line+ and Line− and the windings L₁ₐ and L_{1b} of the first coil used in the double-ended low-pass filter shown at FIG. 4. The windings L₄ and L₅ of the second coil are coupled together so as to form a second transformer L.

In more detail, the first winding L₄ of the second coil is coupled between the first telecommunication input terminal Line+ and a first input 1a of the first winding L₁ₐ of the first coil, whilst the second winding L₅ of the second coil is coupled between the second telecommunication input terminal Line− and a first input 1b of the second winding L_{1b} of the first coil.

A first resistor R₁ is further connected in parallel across the first winding L₄ of the second coil, whilst a second resistor R₂ is connected in parallel across the second winding L₅ of this second coil. Finally, a second capacitor C₂ is coupled between the first input 1a of the first winding L₁ₐ of the first coil and the first input 1b of the second winding L_{1b} of this first coil.

In some application, also other impedances (e.g. resistors, capacitors) may be coupled in parallel to the primary winding of the transformers.

As shown in FIG. 4 and FIG. 5, the enhancement circuit for a coil allows implementing complex filter functions, like xDSL splitters, with less components, with smaller size and at lower cost, by reducing the size and the number of coils required for this filter function.

A final remark is that embodiments of the present invention are described above in terms of functional blocks. From the functional description of these blocks, given above, it will be apparent for a person skilled in the art of designing electronic devices how embodiments of these blocks can be manufactured with well-known electronic components. A detailed architecture of the contents of the functional blocks hence is not given.

While the principles of the invention have been described above in connection with specific apparatus, it is to be clearly understood that this description is merely made by way of example and not as a limitation on the scope of the invention, as defined in the appended claims.

1. An enhancement circuit for enhancing the value of a coil of which the winding is coupled between an input terminal and an output terminal, wherein said enhancement circuit comprises:
a second winding coupled to the first mentioned winding so as to form a transformer,
wherein said second winding has a first terminal coupled to a ground terminal and a second terminal coupled to an input of a feedback circuit, and
wherein said feedback circuit is adapted to sense the voltage over said coil and comprises a transconductance amplifier adapted to amplify and to convert the sensed voltage to a current injected in said second winding via said second terminal.

2. The enhancement circuit according to claim 1, wherein a capacitor is coupled between said output terminal and said ground terminal.

3. An enhancement circuit for enhancing the value of a coil of which the winding is coupled between an input terminal and an output terminal, wherein said enhancement circuit comprises:
a second winding and a third winding both coupled to the first mentioned winding so as to form a transformer,
wherein said second winding has a first terminal coupled to a ground terminal and a second terminal coupled to an input of a feedback circuit,
wherein said third winding has a first terminal coupled to said ground terminal and a second terminal coupled to an output of said feedback circuit, and
wherein said feedback circuit is adapted to sense the voltage over said coil and comprises a transconductance amplifier adapted to amplify and to convert the sensed voltage to a current injected in said third winding via the second terminal thereof.

4. An enhancement circuit for enhancing the value of a coil having a pair of windings and used in a double-ended low-pass filter, the first winding of said pair is coupled between a first input terminal and a first output terminal of said low-pass filter, the second winding of said pair is coupled between a second input terminal and a second output terminal of said low-pass filter, a capacitor is coupled between the first output terminal and the second output terminal of said low-pass filter, and said first winding and said second winding are coupled together so as to form a transformer, wherein said enhancement circuit comprises:
a third winding and a fourth winding both coupled to said first and said second windings and belonging also to said transformer,
wherein said third winding has a first terminal coupled to a ground terminal and a second terminal coupled to an input of a feedback circuit,
wherein said fourth winding has a first terminal coupled to said ground terminal and a second terminal coupled to an output of said feedback circuit, and
wherein said feedback circuit is adapted to sense the voltage over said coil and comprises a transconductance amplifier (gm) adapted to amplify and to convert the sensed voltage to a current injected in said fourth winding via the second terminal thereof.

5. The enhancement circuit according to claim 4, wherein the first winding and the second winding of said transformer are balanced.

6. The enhancement circuit according to claim 4, wherein
said low-pass filter further comprises a second coil having a second pair of windings coupled between said first and second input terminals and said first and second windings of the first mentioned coil used in said double-ended low-pass filter,
the first winding of said second coil being coupled between said first input terminal and a first input of the first winding of said first coil,
the second winding of said second coil being coupled between said second input terminal and a first input of the second winding of said first coil,
wherein a first resistor is connected in parallel across the first winding of said second coil and a second resistor is connected in parallel across the second winding of said second coil,
wherein a second capacitor is coupled between the first input of the first winding of said first coil and the first input of the second winding of said first coil,
wherein the first winding and the second winding of said second coil are coupled together so as to form a second transformer.
